(19) United States
(12) Patent Application Publication
(10) Pub. No.: US 2016/0100353 A1
(43) Pub. Date: Apr. 7, 2016

(54) METHOD OF DYNAMIC ADMISSION CONTROL APPLICABLE TO PROSE SERVER AND USER EQUIPMENT AND RELATED APPARATUSES USING THE SAME

(71) Applicant: Industrial Technology Research Institute, Hsinchu (TW)

(72) Inventor: Stephan Gleixner, Hsinchu County (TW)

(21) Appl. No.: 14/873,188

(22) Filed: Oct. 1, 2015

Related U.S. Application Data
(60) Provisional application No. 62/058,104, filed on Oct. 1, 2014.

(51) Int. Cl. H04W 48/16; H04M 15/00; H04W 76/02

(52) U.S. Cl. CPC H04W 48/16; H04W 76/023; H04M 15/66

(57) ABSTRACT

The disclosure is directed to a method of dynamic admission control applicable to a ProSe server and a Prose UE and related apparatuses using the same method. In one of the exemplary embodiments, the disclosure is directed to a method which includes not limited to receiving an ARP setting table which indicates a plurality of ARP settings for each wireless device; receiving, from the wireless device, a wireless signal which indicates that the wireless device has enabled a D2D relay functionality; and modifying the first ARP setting of the wireless device to be a second ARP setting of the wireless device according to the ARP settings table in response to that the wireless device has enabled the relay functionality, wherein the second ARP setting has a higher priority level than the first ARP setting.

### CROSS REFERENCE TO RELATED APPLICATION

This application claims the priority benefit of U.S. provisional application Ser. No. 62/058,104, filed on Oct. 1, 2014. The entirety of the above-mentioned patent application is hereby incorporated by reference herein and made a part of specification.

### TECHNICAL FIELD

The present disclosure is directed to a method of dynamic admission control applicable to a ProSe server and a Prose UE and related apparatuses using the same method.

### BACKGROUND

ProSe is a Third Generation Partnership Project (3GPP) term for device-to-device (D2D) communications in which at least two devices that are in proximity of each other would communicate directly with each other and not relying on an infrastructure to deliver all the messages in between. For 3GPP ProSe Release 12 a ProSe UE-to-Network Relay could be defined as a UE that provides a functionality to support connectivity to unicast services for Remote UEs. An Remote UE could be defined as a ProSe-enabled Public Safety UE that is not served by E-UTRAN but communicates with a Packet Data Network (PDN) via a ProSe UE-to-Network Relay. It could be required in the future that an authorized ProSe-enabled Public Safety UE is capable of being enabled or disabled to function as a relay to or from a network for other ProSe-enabled Public Safety UEs which are unable to access the network.

For a public safety ProSe-enabled UE, the following uses may occur. (1) A public safety ProSe enabled UE may operate as relay upon attachment to the network. (2) A public safety ProSe enabled UE may operate at some point in time as a relay when the relay function is enabled by a user or the UE itself or the system. (3) A public safety ProSe-enabled UE operates as relay but at some point in time the relay function is disabled by a user or the UE itself such as when the battery is low for instance. (4) A public safety ProSe-enabled UE operating as a relay with 0 remote users. (5) A public safety ProSe-enabled UE operating as a relay with n remote users where n≠0. (6) A public safety ProSe-enabled UE operating as a relay with m remote users, where m>n. In order to dynamically adjust the priority level and other settings for the allocation and retention of bearers, the entity that handles the ARP may require information with regard to how a public safety ProSe-enabled UE operates within a network.

A network may impose requirements for quality of service (QoS) parameters per bearer or per bearer aggregate. A QoS class identifier (QCI) is a parameter which is typically preconfigured by the network operator and is used to control packet forwarding treatment. A network operator may also define allocation and retention priority (ARP) for which one of the primary purposes is to decide whether a bearer establishment or modification request could be accepted or rejected under the circumstance of resource limitations. Moreover, ARP may provide the capability to preempt an existing radio bearer and to accept a new radio bearer request in a scenario such as network overload.

ARP is stored in the home subscriber server (HSS) typically on a per APN basis: ARP currently has priority levels 1˜15. The pre-emption capability of a network may use ARP to determine whether a bearer with a lower ARP priority level should be dropped to free up required resources. The term pre-emption vulnerability involves determining whether a bearer is susceptible for being dropped by a pre-emption capable bearer with a higher ARP priority value. The term pre-emption capability determining whether a bearer with a lower ARP priority level should be dropped to free up the required resources. For every radio bearer (RB) setup request, an eNB may check its current hard limit capacities. The ARP could be used by the eNB to control the establishment of new RBs when resources are scarce. For example, the eNB may deny a RB request or preempt an existing RB in order to accept a new RB request when a network is overloaded.

US Department of Commerce has stated that the ability to pre-empt users is crucial to a public safety broadband network, as stated in “Public Safety Communications Research (PSCR)—QoS Information—Department of Commerce—Boulder Labs” which is incorporated by reference. Also National Public Safety Telecommunications Council (NPSTC) Broadband Working Group has stated that responders and administrators must have the ability to trigger dynamic priority changes as stated in “NPSTC Broadband Working Group—Priority and QoS Task—Priority and QoS in the Nationwide Public Safety Broadband Network” which is incorporated by reference. 3GPP Release-12 has included a number of ProSe features for public safety and non-public safety networks. Currently, features to further enhance public safety have been contemplated for future releases. According to 3GPP TS 22.278, a ProSe UE-to-Network Relay is a form of relay in which a public safety ProSe-enabled UE would operate as a ProSe E-UTRA Communication relay between a public safety ProSe-enabled UE and the ProSe-enabled network using E-UTRA. Moreover, additional requirements for quality of service (QoS) and priority and pre-emption of ProSe communication sessions may also be considered.

A ProSe-enabled network may also rely upon ARP indicating a priority level for the allocation and retention of bearers. In particular, a ProSe-enabled network may use ARP to decide whether to accept a request to establish a bearer or to reject a request when resources are limited. When performing admission control with limited network resources, a ProSe-enabled network may use the ARP to prioritize the establishing or modifying of bearers and may subsequently allow bearers with a higher ARP have a higher priority of access than bearers with a lower ARP. Also, when pre-emption has been enabled, a bearer may become a candidate for deletion.

The current mechanism for ARP might not be coherent with the requirements defined for ProSe UE-to-Network Relays when considering the assumption that any kind of relay would have a higher priority level for allocation and retention of bearers in comparison to a regular UE. For instance, according to 3GPP TS 22.278, an authorized public safety ProSe-enabled UE, whether served by E-UTRAN or not, would be capable of being enabled or disabled by a user or a system to act as a relay for other public pafety ProSe-enabled UEs. The above mentioned assumption could be counter intuitive since a UE that becomes a relay should have a different priority level for allocations and retention of bearers in comparison to a regular UE. Therefore, a dynamic admission control mechanism for a ProSe UE-to-Network Relay could be proposed.

### SUMMARY OF THE DISCLOSURE

Accordingly, the present disclosure is directed to a method of dynamic admission control applicable to a ProSe server and a Prose UE and related apparatuses using the same method.

In one of the exemplary embodiments, the present disclosure is directed to a method of dynamic admission control applicable to a ProSe server. The method would include but is not limited to receiving an ARP setting table which indicates a plurality of ARP settings per wireless device; receiving, from the wireless device, a wireless signal which indicates that the wireless device has enabled a D2D relay functionality; and modifying the first ARP setting of the wireless device to be a second ARP setting of the wireless device according to the ARP setting table in response to that the wireless device has enabled the relay functionality, wherein the second ARP setting has a higher priority level than the first ARP setting.

In one of the exemplary embodiment, the present disclosure is directed to a method of dynamic admission control applicable to a ProSe-capable user equipment (UE). The method would include not limited to establishing a radio bearer having a first allocation and retention priority (APR) setting; enabling a device to device (D2D) relay functionality; modifying the first ARP setting of the UE to be a second ARP setting of the wireless device in response to that the wireless has enabled the relay functionality, wherein the second ARP setting has a higher priority level than the first ARP setting; and transmitting a wireless signal which indicates that the wireless device has enabled the D2D relay functionality.

In one of the exemplary embodiment, the present disclosure is directed to a ProSe server. The ProSe server would include but is not limited to a storage medium; a transceiver; and a processor coupled to the storage medium and the transceiver and is configured at least for: receiving an ARP setting table which indicates a plurality of ARP settings per wireless device and storing the ARP setting table in the storage medium; receiving, via the transceiver, a wireless signal which indicates that the wireless device has enabled a D2D relay functionality from the wireless device; and modifying the first ARP setting of the wireless device to be a second ARP setting of the wireless device according to the ARP setting table in response to that the wireless device has enabled the relay functionality, wherein the second ARP setting has a higher priority level than the first ARP setting.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspects and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a flow chart which illustrates a proposed method of dynamic admission control applicable to a ProSe server.

FIG. 2 is a flow chart which illustrates a proposed method of dynamic admission control applicable to a ProSe-capable user equipment (UE).

FIG. 3 illustrates the hardware components of an exemplary ProSe server in terms of functional block diagrams in accordance with the disclosure.

FIG. 4 illustrates the hardware components of an exemplary ProSe-capable UE in terms of functional block diagrams in accordance with the disclosure.

FIG. 5 is a conceptual diagram illustrating a first exemplary embodiment of the proposed method of the disclosure.

FIG. 6 is a conceptual diagram illustrating a first exemplary embodiment of the proposed method of the disclosure.

FIG. 7 illustrates an exemplary UE-to-Network Relay ARP setting table in accordance with the disclosure.

FIG. 8A-8B are conceptual diagrams illustrating a second exemplary embodiment of the proposed method of the disclosure.

FIG. 9 illustrates a simplified network diagram in accordance with one of the exemplary embodiments of the disclosure.

FIG. 10 illustrates a first example of establishing a dedicated bearer for a UE-to-Network Relay in accordance with one of the exemplary embodiments of the disclosure.

FIG. 11 illustrates a second example of establishing a dedicated bearer for a UE-to-Network Relay in accordance with one of the exemplary embodiments of the disclosure.

FIG. 12 illustrates a first example of modifying a dedicated bearer for a UE-to-Network Relay in accordance with one of the exemplary embodiments of the disclosure.

FIG. 13 illustrates a second example of establishing a dedicated bearer for a UE-to-Network Relay in accordance with one of the exemplary embodiments of the disclosure.

FIG. 14 illustrates a third example of establishing a dedicated bearer for a UE-to-Network Relay in accordance with one of the exemplary embodiments of the disclosure.

FIG. 15 illustrates an example of modifying a dedicated bearer for a UE-to-Network Relay when a high priority UE attaches to a relay in accordance with one of the exemplary embodiments of the disclosure.

FIG. 16 illustrates an example of accepting a high priority UE during high network traffic in accordance with one of the exemplary embodiments of the disclosure.

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

The disclosure proposes different priority levels and other settings for the allocation and retention of bearers for public safety ProSe-enabled UEs, and the priority levels and other settings would depend on whether the public safety ProSe-enabled UEs have been activated to operate as a relay or not as well as how many remote users they serve. In addition, if a high priority remote user attaches to the relay, the disclosure would provide the possibility to modify the ARP setting of the UE-to-Network Relay EPS bearer in order to avoid a pre-emption of that EPS bearer. The disclosure is coherent with the existing 3GPP allocation and retention priority (ARP) mechanisms but enhanced in order to support ProSe enabled relays and UEs.

Moreover, the disclosure also proposes a Public Safety ProSe-enabled UE that acts as a relay to accept only communication requests from higher prioritized remote users in order not to get overloaded. Under circumstances when a network is already overloaded, bearers with lower ARP priorities could be released so as to create resources for users with higher ARP priorities. In addition, if a high priority remote user attaches to a relay, the disclosure provides a mechanism to modify the ARP setting of the UE-to-Network Relay EPS bearer in order to avoid a pre-emption of that EPS bearer. The current ProSe Release 13 framework has not considered QoS related issues such as ARP or QCI thus consequently may cause the UE-to-Network Relay to reject connection requests from high priority remote users in case of network overload. Also if a high priority user has gained network access, the eNB would even release the UE-to-Network Relay EPS bearer that carries the connection of the high priority user. Therefore, the proposal would enable high priority users to access the network without being pre-empted even if the UE-to-Network Relay is in an overload situation. Moreover the eNB cannot release the UE-to-Network Relay EPS bearer that carries the connection of the high priority user.

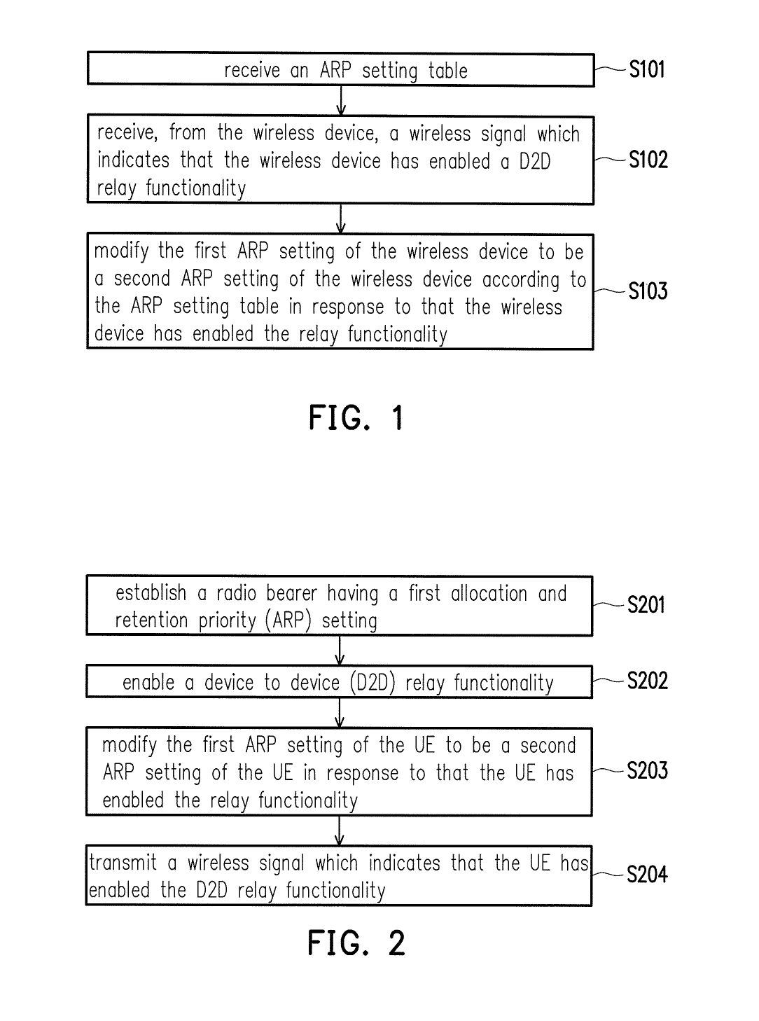

FIG. 1 is a flow chart which illustrates a proposed method of dynamic admission control from the perspective of a ProSe function server. In step S101, the ProSe function server would receive an allocation and retention priority (ARP) table which indicates a plurality of ARP settings per wireless device. In one of the exemplary embodiment, the ARP settings could be received as an ARP settings table from a home subscriber server (HSS). In step S102, the ProSe function server would receive from the wireless device a wireless signal which indicates that the wireless device has enabled D2D relay functionality. In step S103, the Prose function server would modify the first ARP setting of the wireless device to be a second ARP setting of the wireless device according to the ARP setting table in response to that the wireless device has enabled the relay functionality. The above mentioned second ARP setting would have a higher priority level than the first ARP setting.

In one of the exemplary embodiments, the ProSe function server would modify the second ARP setting of the wireless device to a third ARP setting in response to that the wireless device is serving n users, wherein n>0. The third ARP setting would have a higher priority than the second ARP setting. The ProSe function server would subsequently update the ARP settings of the APR table which records the ARP settings of the plurality of wireless devices.

In one of the exemplary embodiments, the ProSe function server would modify the third ARP setting of the wireless device to a fourth ARP setting in response to the event when the wireless device is serving m users, wherein m>n and the fourth ARP setting has a higher priority than the third ARP setting. The ProSe function server would subsequently update the ARP settings of the ARP table which records the ARP settings of the plurality of wireless devices.

In one of the exemplary embodiments, the ProSe function server would modify the second ARP setting of the wireless device to a third ARP setting in response to that the wireless device is a high priority wireless device. The third ARP setting has a higher priority than the second ARP setting.

In one of the exemplary embodiments, the ProSe function server would modify the ARP settings for the wireless device as being invulnerable for pre-emption in response to that the wireless device has enabled the D2D relay functionality.

In one of the exemplary embodiments, the ProSe function server would modify the ARP settings for the wireless device as having pre-emption capability in response to that the wireless device is serving n users, wherein n>0.

In one of the exemplary embodiments, the ProSe function server would inform a Policy Charging and Rules Function (PCRF) that the wireless device has enabled the D2D relay functionality in response to the event that the wireless device has enabled the D2D relay functionality.

In one of the exemplary embodiments, the ProSe function server would change a PVF information element (IE) of the ARP setting of the wireless device in response to the event that the wireless device has enabled the relay functionality.

In one of the exemplary embodiments, the ProSe function server would change a PCF information element (IE) of the ARP setting of the wireless device in response to the event that the wireless device is serving n users, wherein n>0.

FIG. 2 is a flow chart which illustrates a proposed method of dynamic admission control applicable to a ProSe capable wireless device which may serve as a UE to network relay. In step S201, the wireless device would establish an EPS bearer having a first allocation and retention priority (ARP) setting. In step S202, the wireless device would enable a device to device (D2D) relay functionality. In step S203, the wireless device would modify the first ARP setting of the UE to be a second ARP setting of the wireless device in response to that the wireless has enabled the relay functionality. The second ARP setting has a higher priority level than the first ARP setting. In step S204, the wireless device would transmit a wireless signal which indicates that the wireless device has enabled the D2D relay functionality.

In one of the exemplary embodiments, the wireless device would modify the second ARP setting of the EPS bearer to a third ARP setting in response to that the wireless device is serving n users, wherein n>0 and the third ARP setting has a higher priority than the second ARP setting.

In one of the exemplary embodiments, the wireless device would modify the third ARP setting of the radio bearer to a fourth ARP setting in response to that the wireless device is serving m users, wherein m>n and the fourth ARP setting has a higher priority than the third ARP setting.

In one of the exemplary embodiments, the wireless device would modify the second ARP setting of the radio bearer to a third ARP setting in response to that the wireless device is a high priority wireless device, and the third ARP setting has a higher priority than the second ARP setting.

In one of the exemplary embodiments, the wireless device is invulnerable for preemption in response to that the wireless device has enabled the D2D relay functionality.

In one of the exemplary embodiments, the wireless device would possess pre-emption capability in response to that the wireless device is serving n users, wherein n>0.

In one of the exemplary embodiments, the wireless device would release a remote user equipment (UE) having a lowest APR setting in response to the event when the wireless device has reached a maximum capability.

In one of the exemplary embodiments, the wireless device would only accept the remote UE having a high ARP setting in response to the event when the wireless device has reached a maximum capacity.

In one of the exemplary embodiments, the wireless device would change a PVF information element (IE) of the ARP setting of the radio bearer in response to the event when the wireless device has enabled the relay functionality.

In one of the exemplary embodiments, the wireless device would change a PCF information element (IE) of the ARP setting of the radio bearer in response to the event when the wireless device is serving n users, wherein n>0.

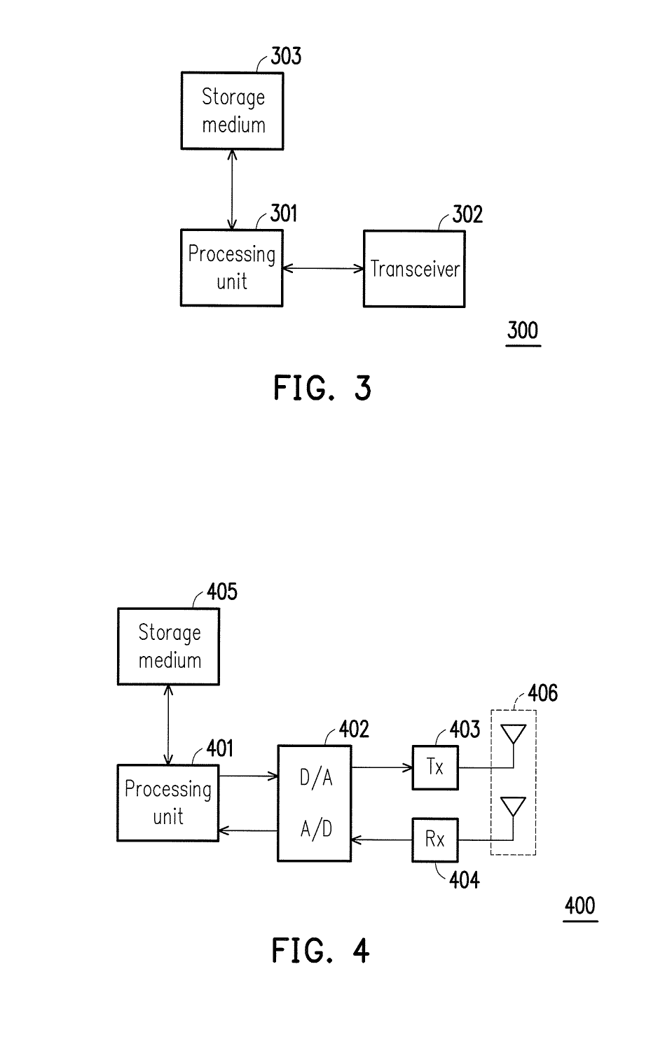

FIG. 3 illustrates the hardware components of an exemplary ProSe function server 300 in terms of functional block diagrams in accordance with the disclosure. The exemplary ProSe function server 300 may include not limited to a processing unit 301, a transceiver 302 electrically coupled to the processing unit 302, and a storage medium 303 coupled to the processing unit 303. The processing unit 301 may contain one or a plurality of processors or central processing units (CPUs) and is configured to performed the method as described in FIG. 1 and its written descriptions. Also, the functions of the processing unit 301 could be implemented by using programmable units such as a micro-processor, a micro-controller, digital signal processor (DSP) chips, a field-programmable gate array (FPGA), etc. The functions of the processing unit 301 may also be implemented with separate electronic devices or ICs, and functions performed by the processing unit 301 may also be implemented within the domains of either hardware or software. The transceiver 302 is controlled by the processing unit 301 to transmit or receive data. The transceiver 302 would be a cabled or wireless hardware module. The storage medium 303 may be a fixed or a movable device in any possible forms including a non-transitory computer readable recording medium such as a random access memory (RAM), a read-only memory (ROM), a flash memory or other similar devices, or a combination of the above-mentioned devices.

FIG. 4 illustrates the hardware components of an exemplary ProSe relay capable wireless device 400 in terms of functional block diagrams in accordance with the disclosure. A wireless device in this disclosure would support public safety D2D relay capabilities and could represent various embodiments which for example could include but not limited to a desktop computer, a laptop, a computer, a server, a client, a workstation, a personal digital assistant (PDA), a tablet personal computer (PC), a scanner, a telephone device, a pager, a camera, a television, a hand-held video game device, a musical device, a wireless sensor, and so like. In some applications, a wireless device may be a fixed computer device operating in a mobile environment, such as a bus, train, an airplane, a boat, a car, and so forth.

From the hardware perspective, the exemplary wireless device of FIG. 4 may include not limited to a processing unit 401 electrically coupled to one or more D/A/A/D converters 402, a wireless transmitter 403, a wireless receiver 404, a storage medium 405, and an antenna unit 406. The antenna unit could be one antenna or an antenna array. The processing unit 401 could be configured to perform the proposed method of FIG. 2 and its related written descriptions. Also, the processing unit 401 could be implemented by using programmable units such as a micro-processor, a micro-controller, DSP chips, a FPGA, etc. The functions of the processing 401 may also be implemented with separate electronic devices or ICs, and functions performed by the processor 401 may also be implemented within the domains of either hardware or software.

The D/A/A/D converters 402 is configured to convert from an analog signal format to a digital signal format during uplink signal processing and from a digital signal format to an analog signal format during downlink signal processing. The transmitter 403 could be controlled by the processing unit 401 to transmit wireless signals and the receiver 404 could be controlled by the processing unit to receive wireless signals. The storage medium 405 could be a fixed or a movable device in any possible forms including non-transitory computer readable recording medium such as a RAM, a ROM, a flash memory or other similar devices, or a combination of the above-mentioned devices.

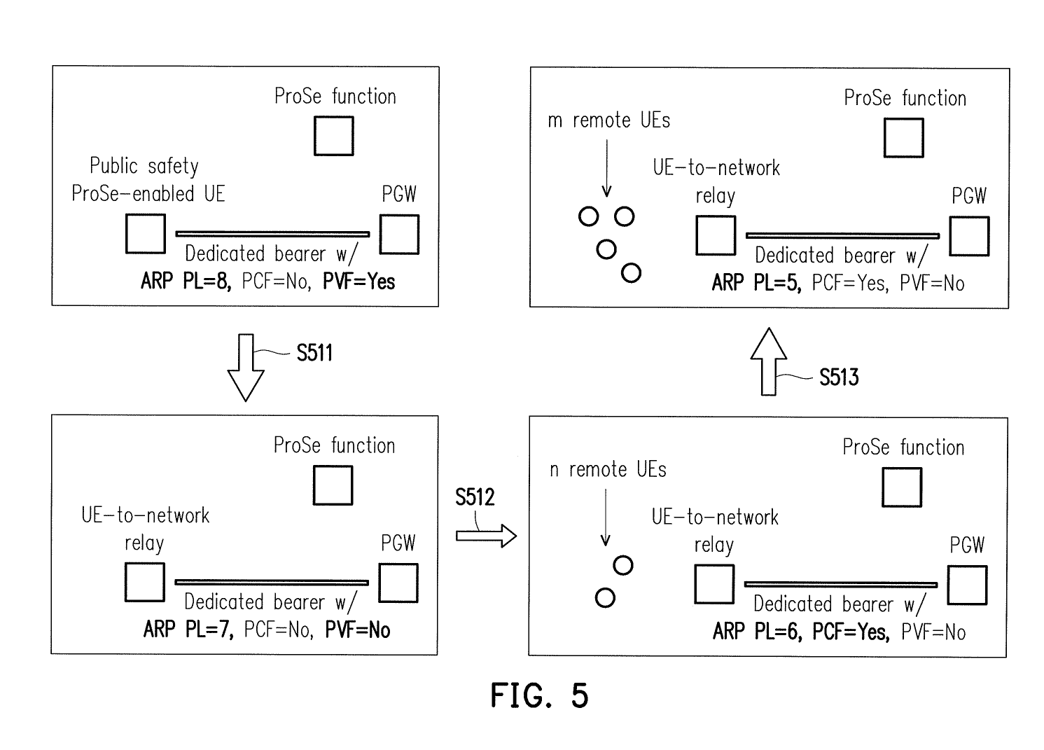

FIG. 5 is a conceptual diagram illustrating a first exemplary embodiment of the proposed method of the disclosure. The first exemplary embodiment involves at least, but not limited to, a public safety ProSe-capable UE which is capable of serving as a UE-to-Network Relay interacting with a ProSe function and a packet gateway (PGW) situated in the non-access stratum (NAS) through a radio access network (not shown). The ProSe function and PGW both refer to well-known entities in a core network. When a ProSe-enabled UE informs the ProSe function whether it has begun serving as a relay as well as the number of Remote UEs it serves, the ProSe function would record such information and subsequently transmit such information to the PGW. The PGW would then adjust the QoS related parameters such as ARP accordingly during establishments or modification of EPS bearers.

Thus, in the scenario of FIG. 5, a public safety ProSe enabled UE as an example is assumed to have a dedicated bearer established with the network with ARP priority level (PL) of 8, a pre-emption capability flag (PCF) set to ‘no’, and a pre-emption vulnerability flag (PVF) set to ‘yes’ (depicted in upper left corner). In step S511, in response to the public safety ProSe enabled UE begun serving as a relay, the dedicated bearer would be modified to have a higher ARP priority level which in this case is increased to 7. Also, the PVF setting would be changed to ‘no’ instead of ‘yes’ (depicted in lower left corner). In step S512, in response to the number of remote UEs that is being relayed by the public safety ProSe enabled UE has reached ‘n’ remote UEs, where ‘n’ is greater than zero, then the dedicated bearer would be modified to have an increased ARP level which is this case is increased to 6. The PCF setting would be modified to ‘yes’, and while the PVF setting would remain as ‘no’ (depicted in lower right corner). In step S513, in response to the number of remote UEs that is being relayed by the public safety ProSe enabled UE has reached ‘m’ remote UEs, where ‘m’ is greater than ‘n’, then the ARP level of the dedicated radio bearer would be increased to 5 while PCF setting would remain ‘yes’ and the PVF setting would remain ‘no’ (depicted in upper right corner). For the example of FIG. 5, ‘m’ and ‘n’ are both non-zero integers as ‘m’ could be 3 and ‘n’ could be 2. However, they are not limited by the disclosure to these exact numbers.

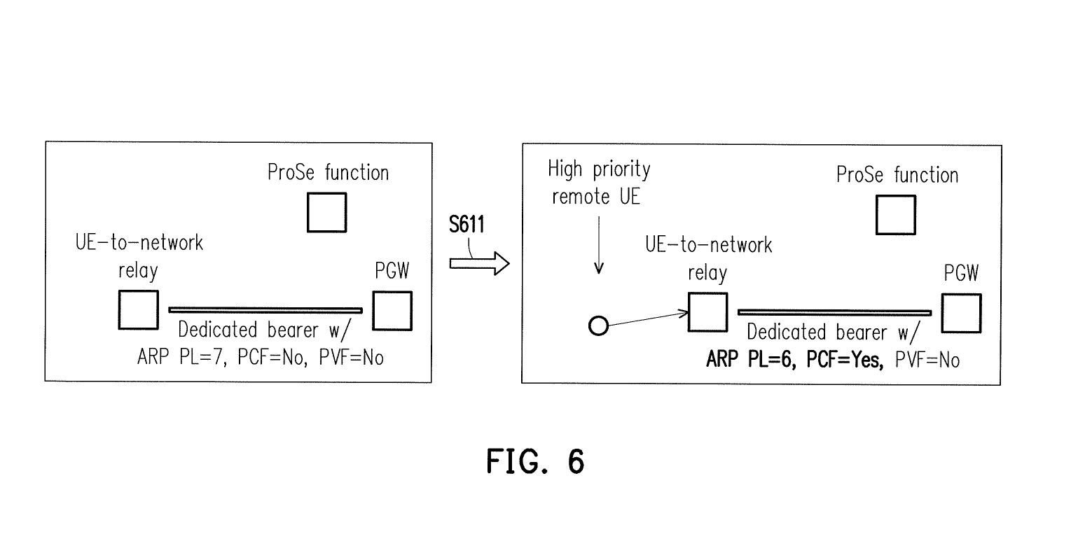

FIG. 6 is a conceptual diagram illustrating a second exemplary embodiment of the proposed method of the disclosure. In this scenario, in step S611, in response to a high priority remote UE being served by the public safety ProSe-enabled UE, the dedicated EPS bearer established between the public safety ProSe-enabled UE and the network would increase its ARP setting, and the PCF setting would change from ‘no’ to ‘yes’ (depicted on right side). As an example, the ARP setting is increased from 7 to 6. The high priority remote UE as example could be such as a law enforcement officer making a call, a government official making a call, or a 911 call.

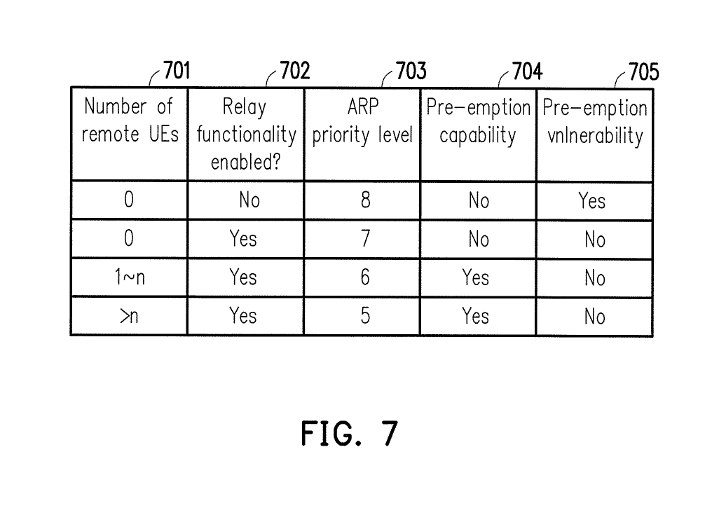

FIG. 7 illustrates an exemplary UE-to-Network Relay ARP setting table in accordance with the disclosure. The ARP setting table is transmitted from a core network entity which could be HSS to a ProSe function server. The table may also be transmitted from an application server. The table would record parameters such as the number of remote UEs 701, whether relay functionality is enabled 702, the ARP priority level 703, pre-emption capability 704, and pre-emption vulnerability. For example, if a public safety ProSe enabled UE has not activated the relay functionality and thus is serving 0 remote UEs, by referring to the table of FIG. 7, the ProSe function server would inform such settings to a PGW. The PGW would then adjust the QoS parameters accordingly such that a dedicated EPS bearer between the public safety ProSe enabled UE and the network would have the ARP priority level of 8, would not be pre-emption capable, and would be vulnerable to pre-emption. Similarly, if the public safety ProSe enabled UE is serving between 1˜n remote UEs where n is an integer and the relay functionality has been enabled, then the dedicated EPS bearer established between the public safety Pro-Se enabled UE and the network would have a pre-emption capability and would not be vulnerable to pre-emption.

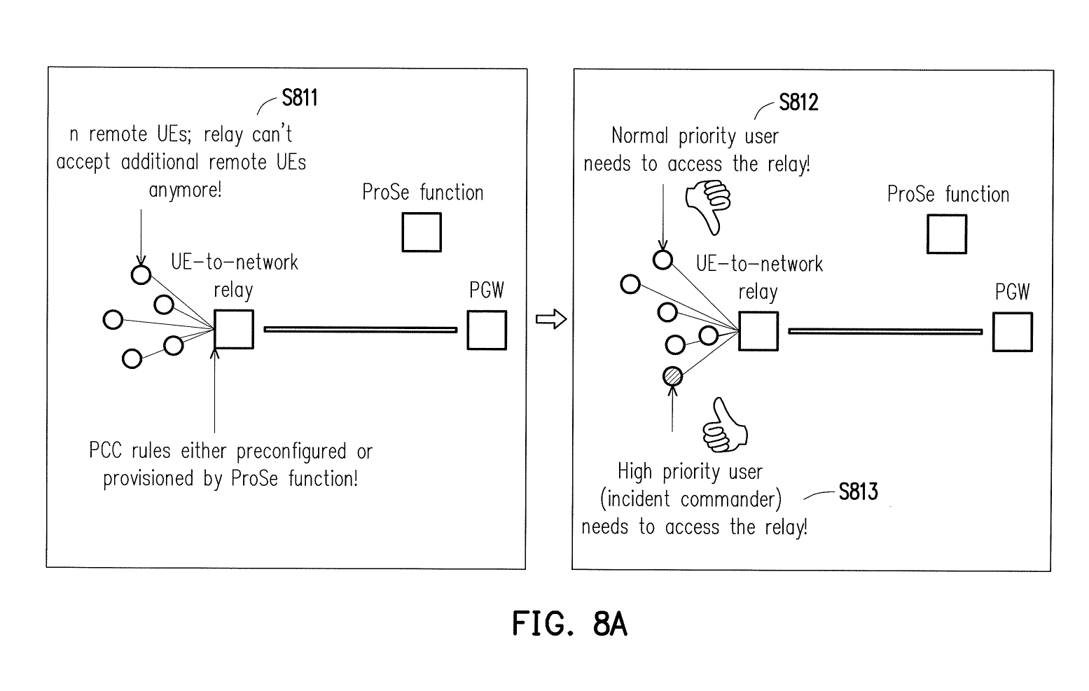

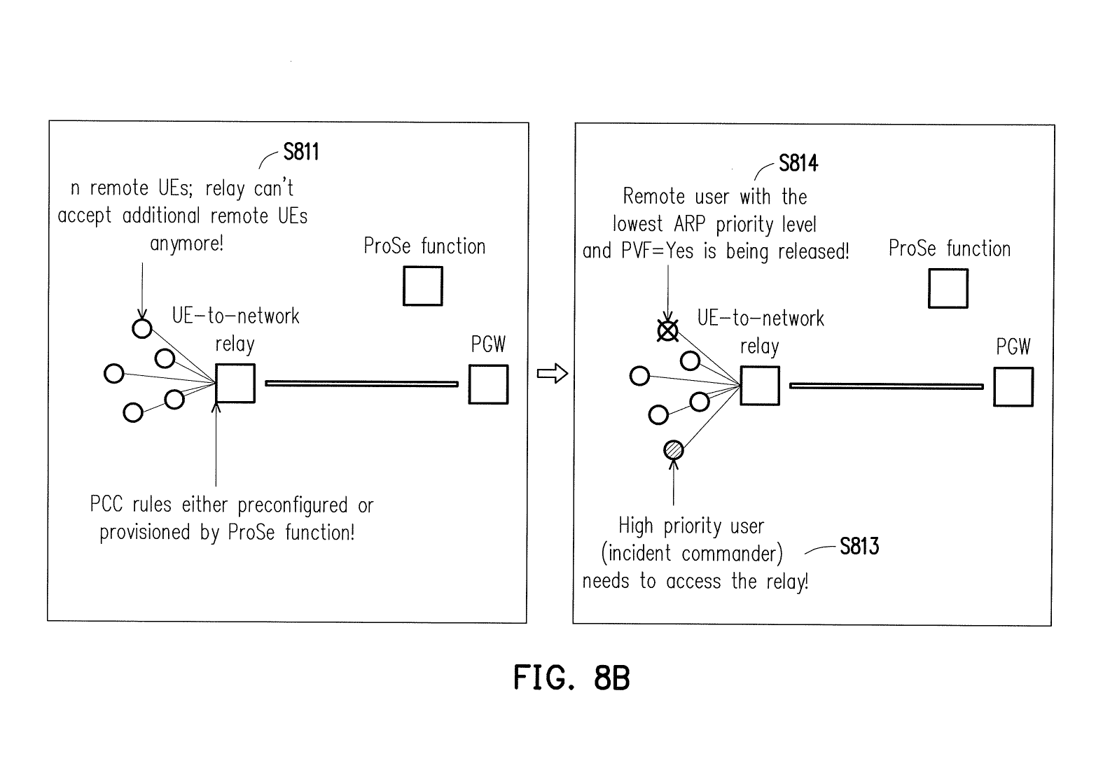

FIG. 8A-8B are conceptual diagrams illustrating a third exemplary embodiment of the proposed method of the disclosure. In step S811, after the relaying capacity of a public safety ProSe-enabled UE has reached a maximum capacity according to PCC rules either preconfigured or provisioned by ProSe function, the public safety ProSe-enabled UE cannot relay any more additional users. However, in step S812, a remote UE having normal priority would need to access the relay. Also, in step S813, a high priority user such as an incident commander also needs to access the relay. Since the UE-to-Network Relay reached its capacity limits it cannot admit the UE with normal priority. However it should be possible (according to PCC rules) to admit the high priority user. In step S814, the public safety ProSe enabled UE would in response release the remote UE which has the lowest APR priority level as well as the PVF set as ‘yes’ in order to free up resources to be able to admit the high priority user.

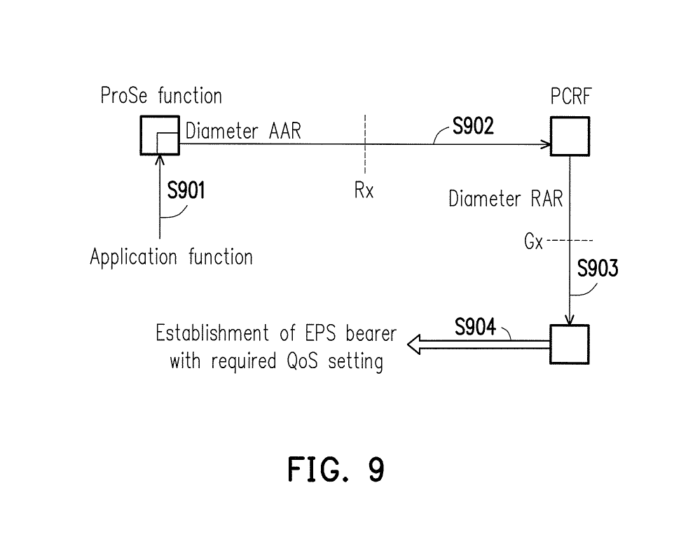

To elucidate in further detail, FIG. 9 illustrates a simplified network diagram in accordance with one of the exemplary embodiments of the disclosure. In FIG. 9, in step S901, an application function within the ProSe function would inform the ProSe function of information including whether a particular Public Safety ProSe-enabled UE operates as relay or not as well as how many remote UEs are being relayed. In step S902, such information (typically called ‘Service Information’) would be transmitted to the Policy Charging and Rules Function (PCRF) over the Rx interface. The Service Information is used as a basis for PCC decisions at the PCRF and in step S903, the PCRF could then dynamically provision PCC rules to the Policy Charging and Enforcement Function (PCEF) located in the PGW over the Gx interface. In step S904, the PGW would then establish EPS bearer for the public safety ProSe enabled UE with the required QoS setting or it would modify an existing EPS bearer such that it provides the required QoS setting.

The related procedure would be described in further detail as follows. In general, the HSS contains ‘UE-to-Network Relay ARP Setting Table’. The ProSe function (server) would then receive the ‘UE-to-Network Relay ARP Setting Table’ from HSS and saves it either in UE context or as general setting for all ProSe-enabled UEs served by that ProSe Function. In response to the ProSe function receiving information on UEs having enabled their UE-to-Network Relay functionality, the application function in ProSe function would inform the PCRF that a particular ProSe enabled UE has enabled its UE-to-Network Relay functionality. The PCRF would then inform the PGW that particular UE has enabled its UE-to-Network Relay functionality. The PGW would then establish or modify EPS bearer in accordance with required QoS setting, which includes a required ARP.

In another exemplary embodiment, when a ProSe Function receives information on number of Remote UEs a particular UE-to-Network Relay serves, the application function in ProSe function would inform the PCRF a certain number of Remote UEs require a new QoS setting including new ARP setting according to the ‘UE-to-Network Relay ARP Setting Table’. The PCRF would inform the PGW that it has to establish or modify an EPS bearer in accordance with required QoS setting.

When the ProSe function receives information that a high priority user has attached to the UE-to-Network Relay, the ProSe function would check ARP setting for high priority user and compares it with ARP setting of EPS bearer of UE-to-Network relay. If the ARP setting of EPS bearer of UE-to-Network Relay needs to be modified according to some policies in the event such as when the ARP priority level of EPS bearer of UE-to-Network Relay is less than the ARP priority level of a high priority user, the application function in ProSe function would inform the PCRF of such scenario. The PCRF would then inform the PGW that it has to establish or modify an EPS bearer in accordance with required QoS setting.

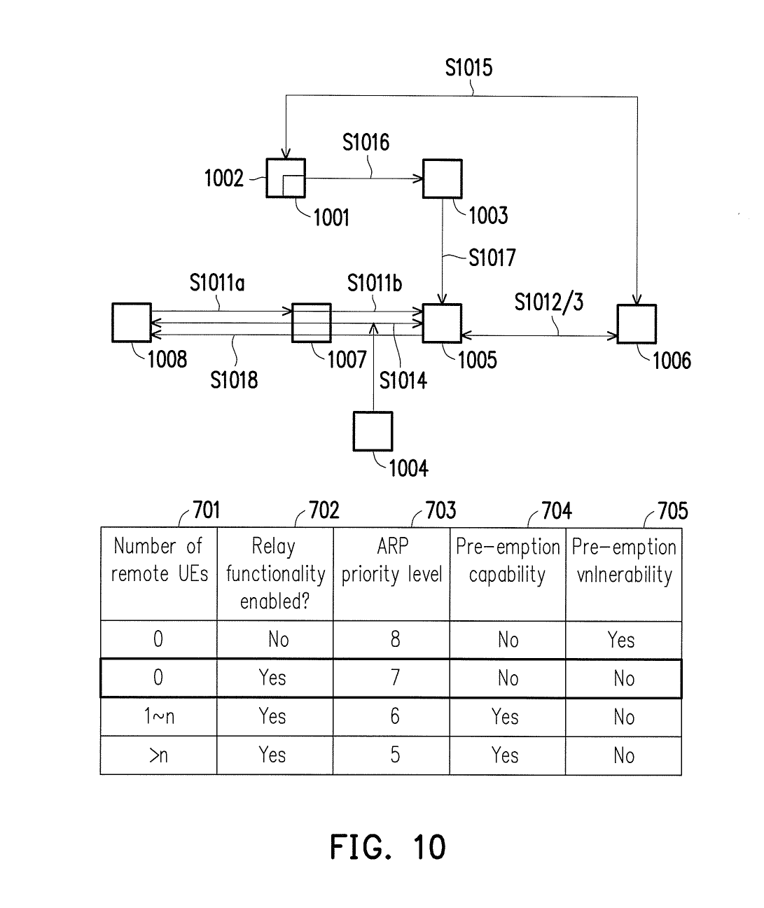

FIG. 10 illustrates a first example of establishing dedicated bearer for a UE-to-Network Relay in accordance with one of the exemplary embodiments of the disclosure. This example describe events transpire within an exemplary network which includes not limited to an application function 1001, a ProSe function 1002 containing the application function 1001, a PCRF 1003, a PGW 1004 an AAA proxy 1005 within the PGW 1004, a HSS/AAA server 1006, a mobility management entity (MME) 1007, and a UE-to-Network Relay 1008. In general, the HSS 1006 would contain the UE-to-Network Relay ARP settings table as a part of the subscription information of the UE 1008, and the ProSe function 1002 and the MME 1007 are assumed to have received the UE-to-Network Relay ARP settings table and saved it in UE context.

In step S1011a, upon an activation of the relay functionality (by system, UE or user), the relay 1008 may transmit a PDN Connectivity Request message including a relay activation indication in the PCO IE to the MME 1007. In step S1011b, the MME 1007 may send a Session Request message including a relay activation indication in the PCO IE to the PGW 1004. In step S1012, the AAA proxy 1005 in the PGW 1004 would transmit an authorization request message to the HSS/AAA Server 1006. In step S1013, the AAA proxy 1005 would receive an authorization response message from the HSS/AAA Server 1006. Upon a successful authentication of the public safety ProSe enabled UE 1008 to act as a UE-to-Network Relay, a default EPS bearer for the relayed traffic may be established.

In step S1015, the HSS 1006 would then informs the ProSe Function 1002, for instance, by using the existing message Insert Subscriber Data that a particular UE now operates as a UE-to-Network Relay. The ProSe function may record such information. In step S1016, the ProSe Function 1002 may trigger the Application function 1001 to signal to the PCRF 1003 over the Rx interface with diameter AAR message that the relay function has been enabled by the UE 1008. In step S1017, the PCRF 1003 would inform the PGW 1004, to establish a dedicated EPS bearer or modify an existing dedicated bearer with the required QoS setting in particularly with the required ARP setting. In step S1018, a dedicated EPS bearer with the required QoS setting could be established between the UE 1008 and the PGW 1005 according to the UE-to-Network Relay ARP setting table such as the one shown on bottom of FIG. 10.

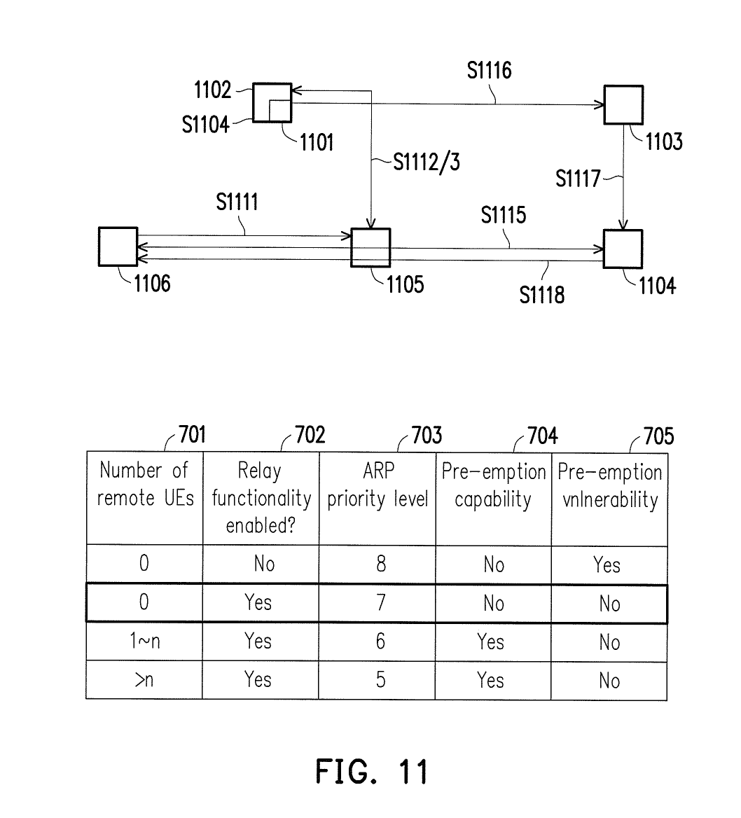

FIG. 11 illustrates a second example of establishing dedicated bearer for a UE-to-Network Relay in accordance with one of the exemplary embodiments of the disclosure. For this example, the authorization mechanism to act as a relay is different from the example of FIG. 10, and the ProSe Function learns that the UE operates as a relay by different means. However, the establishment and modification of the EPS bearer remains the same as described in FIG. 10. The exemplary network of this example includes not limited to an application function 1101, a ProSe function 1102 containing the application function 1101, a PCRF 1103, a PGW 1104, a MME 1105, and a UE-to-Network Relay 1106. In general, the HSS (not shown) would contain the UE-to-Network Relay ARP settings table as a part of the subscription information of the UE 1106, and the ProSe function 1102 and the MME 1105 are assumed to have received the UE-to-Network Relay ARP settings table and saved it in UE context.

In step S1111, upon an activation of the relay functionality, the public safety ProSe-enabled UE 1106 may transmit a PDN Connectivity Request message including a relay activation indication IE to the MME 1105. In step S1112, the MME 1105 may send an authorization request message to the ProSe function 1102. In step S1113, the MME 1105 may receive a response to the authorization request message from the ProSe function 1102. Upon a successful authentication of the public safety ProSe enabled UE 1106 to act as a UE-to-Network Relay, a default EPS bearer for the relayed traffic may subsequently be established. In step S1114, the ProSe function records the information of the UE 1106 setting the relay functionality as being enabled.

In step S1115, the MME 1105 transmit a PDN connection establishment message (default bearer) to the PGW 1104. In step S1116, the application function 1101 of the ProSe function 1102 would inform the PCRF 1103 over the Rx interface with Diameter AAR message that the relay function of the UE 1106 has been enabled. In step S1117, the PCRF 1103 would inform the PGW 1104, to establish a dedicated EPS bearer or modify an existing dedicated bearer with the required QoS setting in particularly with the required ARP setting. In step S1118, the PGW would establish a dedicated radio bearer with the required QoS setting between with UE through the MME 1105 according to the UE-to-Network Relay ARP setting table such as the one shown on bottom of FIG. 11.

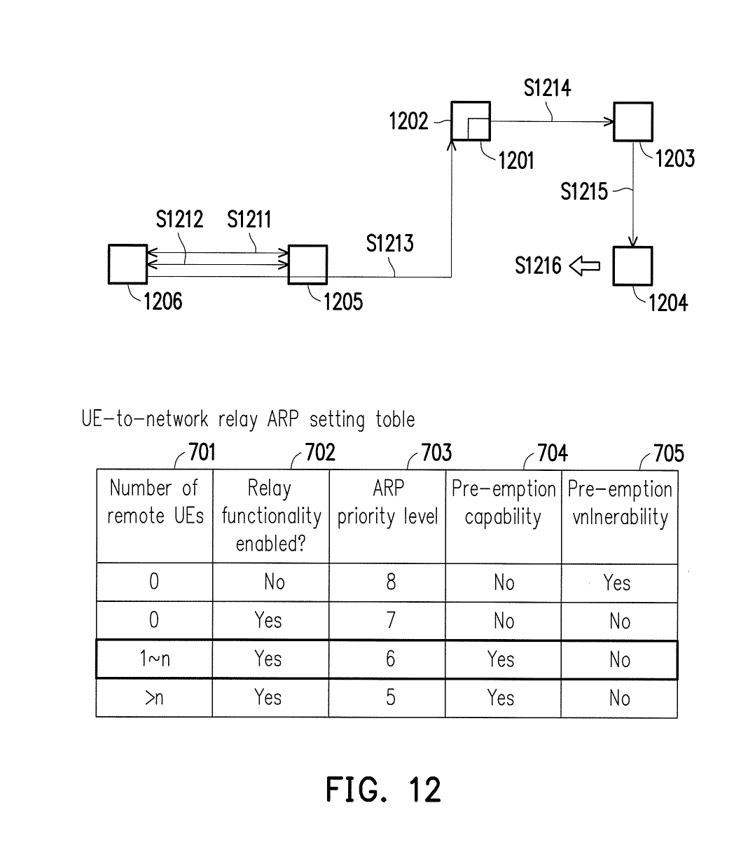

FIG. 12 illustrates a first example of modifying a dedicated bearer for a UE-to-Network Relay in accordance with one of the exemplary embodiments of the disclosure. The mechanism to modify a previously established EPS bearer would depend on how many Remote UEs are being served by a UE-to-Network Relay. It is assumed that a dedicated bearer exists or has been established when a UE was enabled to operate as a relay. When a certain number of Remote UEs are attached to the UE-to-Network Relay, the existing EPS bearer is modified, according to the ‘UE-to-Network Relay ARP Setting Table’. In general, the HSS (not shown) would contain the UE-to-Network Relay ARP settings table as a part of the subscription information of the UE 1206, and the ProSe function 1202 and MME (not shown) are assumed to have received the UE-to-Network Relay ARP settings table and saved it in UE context.

In step S1211, a remote UE 1206 would perform a direct discovery and may discovery one or several relays. If several relays are discovered, one relay is selected. In step S1212, the remote UE 1206 has selected the public safety ProSe enabled UE 1205 which serves as a UE-to-Network Relay and has established a direct one to one communication with the UE 1205 which may assign a dynamic or static IP address to for remote UE 1206. In step S1213, the Remote UE 1206 would notify the ProSe function 1202 that it has successfully attached to the UE-Network Relay 1205. If the ProSe function 1202 is used to authorize the remote UE 1206 to use the UE-to-Network Relay 1205, then sending an explicit notification message is unnecessary. The ProSe function needs to keep track of the number of Remote UEs that have attached to a particular UE-to-Network Relay. In step S1214, the application function 1201 would transmit an AAR message over an Rx interface to the PCRF 1203 about the number of Remote UEs 1206 that have attached to the UE-to-Network Relay 1205. In step S1215, the PCRF 1203 would establish an EPS bearer with the PGW 1204 or modify an existing EPS bearer with the PGW 1204. In step S1216, the PGW 1204 would establish a dedicated EPS bearer with the required QoS setting with the remote UE 1206 through the relay 1205 according to the UE-to-Network Relay ARP setting table such as the one shown on bottom of FIG. 12.

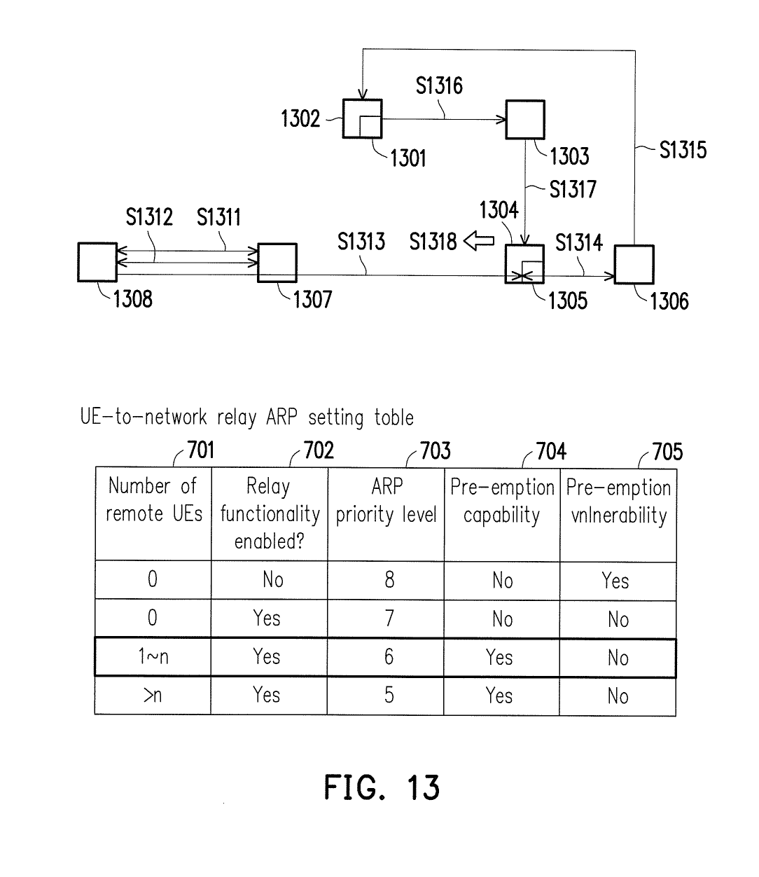

FIG. 13 illustrates a second example of establishing a dedicated bearer for a UE-to-Network Relay in accordance with one of the exemplary embodiments of the disclosure. In general, the HSS 1306 would contain the UE-to-Network Relay ARP settings table. In step S1311, a remote UE 1308 would perform a direct discovery and may discover one or several relays. If several relays are discovered, one relay is selected. In step S1312, the remote UE 1308 has selected the public safety ProSe enabled UE 1307 which serves as a UE-to-Network Relay and has established a direct one to one communication with the UE 1307 which may assign a dynamic or static IP address to for remote UE 1308. In step S1313, the ProSe enabled UE would perfol an authentication request procedure with the AAA proxy 1305. In step S1314, the ProSe enabled UE would receive a response of the authentication request procedure. In step S1315, the HSS 1306 would notify the ProSe function 1302 that the remote UE 1308 has successfully attached to the UE-Network Relay 1307 using for instance the Insert Subscriber Data message. The ProSe function needs to keep track of the number of Remote UEs that have attached to a particular UE-to-Network Relay. In step S1316, the application function 1301 would transmit an AAR message over a Rx interface to the PCRF 1303 about the number of Remote UEs 1308 that have attached to the UE-to-Network Relay 1307. In step S1317, the PCRF 1303 would establish an EPS bearer with the PGW 1404 or modify an existing EPS bearer with the PGW 1404. In step S1308, the PGW 1404 would establish a dedicated EPS bearer with the required QoS setting with the remote UE 1308 through the relay 1307 according to the UE-to-Network Relay ARP setting table such as the one shown on bottom of FIG. 13.

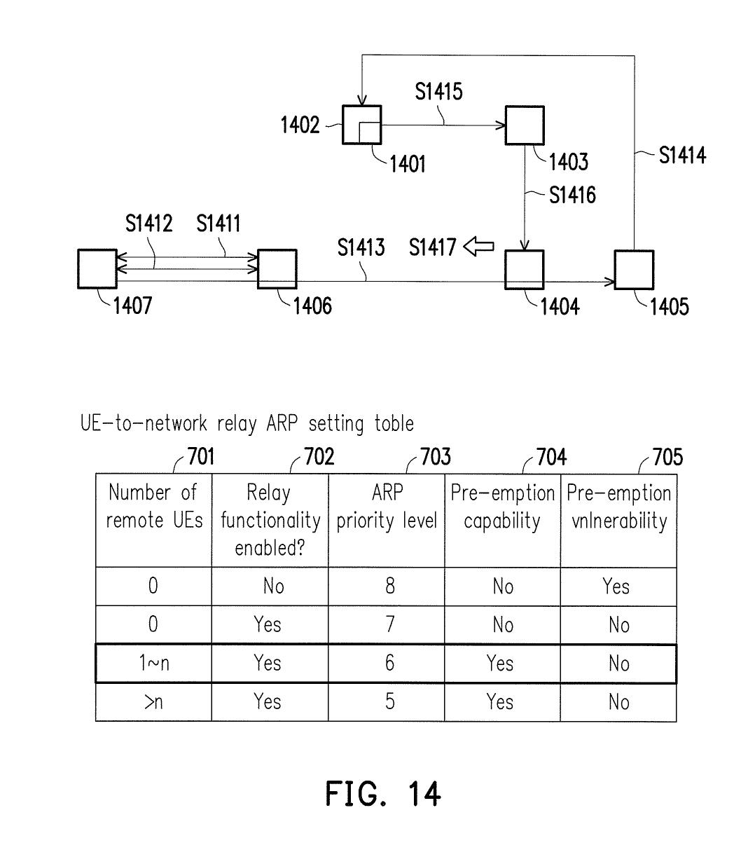

FIG. 14 illustrates a third example of establishing a dedicated bearer for a UE-to-Network Relay in accordance with one of the exemplary embodiments of the disclosure. In general, the HSS 1306 would contain the UE-to-Network Relay ARP settings table and a ProSe function and an MME (not shown) would receive the UE-to-Network Relay ARP settings table and save it in a UE context. In step S1411, a Remote UE 1407 would perform a direct discovery and may discovery one or several relays. If several relays are discovered, one relay is selected. In step S1412, the Remote UE 1407 has selected the public safety ProSe-enabled UE 1406 which serves as a UE-to-Network Relay and has established a direct one to one communication with the UE 1407 which may assign a dynamic or static IP address to for Remote UE 1407. In step S1413, the ProSe enabled UE 1406 would perform an authentication request procedure with an application server 1405 (e.g., GCSE server) which may handle applications related to D2D applications. In step S1414, the application server 1405 would inform the ProSe server 1402 that the ProSe-enabled UE 1407 has successfully attached to the UE-to-Network Relay 1406. The ProSe function needs to keep track of the number of Remote UEs that have attached to a particular UE-to-Network Relay. In step S1415, the application function 1401 would transmit an AAR message over an Rx interface to the PCRF 1403 about the number of Remote UEs 1407 that have attached to the UE-to-Network Relay 1406. In step S1416, the PCRF 1403 would establish an EPS bearer with the PGW 1404 or modify an existing EPS bearer with the PGW 1404. In step S1407, the PGW 1404 would establish a dedicated EPS bearer with the required QoS setting with the Remote UE 1407 through the relay 1406 according to the UE-to-Network Relay ARP setting table such as the one shown at the bottom of FIG. 14.

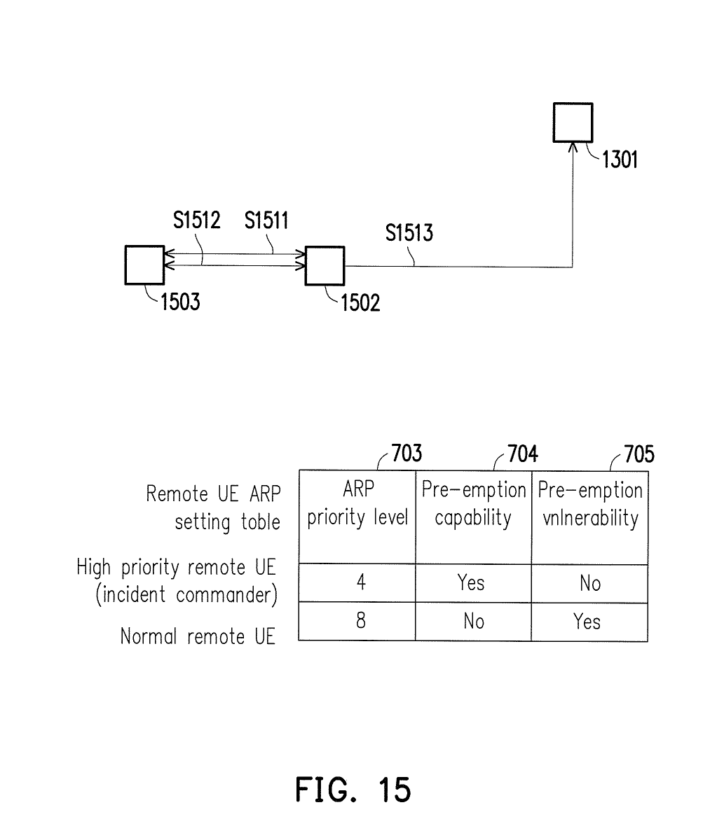

FIG. 15 illustrates an example of modifying a dedicated bearer for a UE-to-Network Relay when a high priority UE attaches to a relay in accordance with one of the exemplary embodiments of the disclosure. When a high priority remote user such for instance an incident commander attaches to the UE-to-Network Relay 1502, the ARP setting of the EPS bearer between UE-to-Network Relay 1502 and PDN gateway would need to be modified in order to avoid a pre-emption of that EPS bearer. For instance it is assumed that the UE-to-Network Relay has established an EPS bearer with ARP priority level 6 and a pre-emption vulnerability flag set to ‘yes’. When the high priority user such as an incident commander attaches to the UE-to-Network Relay 1502, it should not be possible anymore to pre-empt the EPS bearer. Therefore, the pre-emption vulnerability flag would be set to ‘no’. Also the ARP priority level would be raised to match the ARP priority level of the high priority user according to the ‘Remote UE ARP setting table’.

In step S1511, it is assumed that the ProSe Function 1501 has received a ‘Remote UE ARP Setting Table’. Also the ProSe Function 1501 has received PCC rules and thresholds. For example, if UE-to-Network Relay operates at 80% of capacity, only Remote UEs with ARP priority level <5 are allowed to use that relay. In step S1512, the remote UE 1503 would perform a direct discovery for a public safety ProSe enabled UE 1502 which serves as a UE-to-Network Relay.

In step S1513, upon receiving an attachment request from the Remote UE 1503, the UE-to-Network Relay 1502 would check for the ARP setting of the Remote UE 1503 by referring to an ARP settings table such as the one below FIG. 15. The ARP setting of the Remote UE 1503 would then be compared against the ARP setting of EPS bearer of UE-to-Network Relay 1502. If ARP setting of EPS bearer of UE-to-Network Relay 1502 needs to be modified such as when the ARP priority level of EPS bearer of UE-to-Network Relay 1502 is less than ARP priority level of a high priority UE, an application function in the ProSe function 103 would inform the PCRF which would then inform the PGW that it has to establish or modify the EPS bearer of the UE-to-Network Relay 1502. UE-to-Network Relay 1502 could have received ARP settings table of the remote UE 1503 already, for instance, the direct discovery procedure back in step S1501. In such case, accessing the ProSe function 1501 may not be required at all.

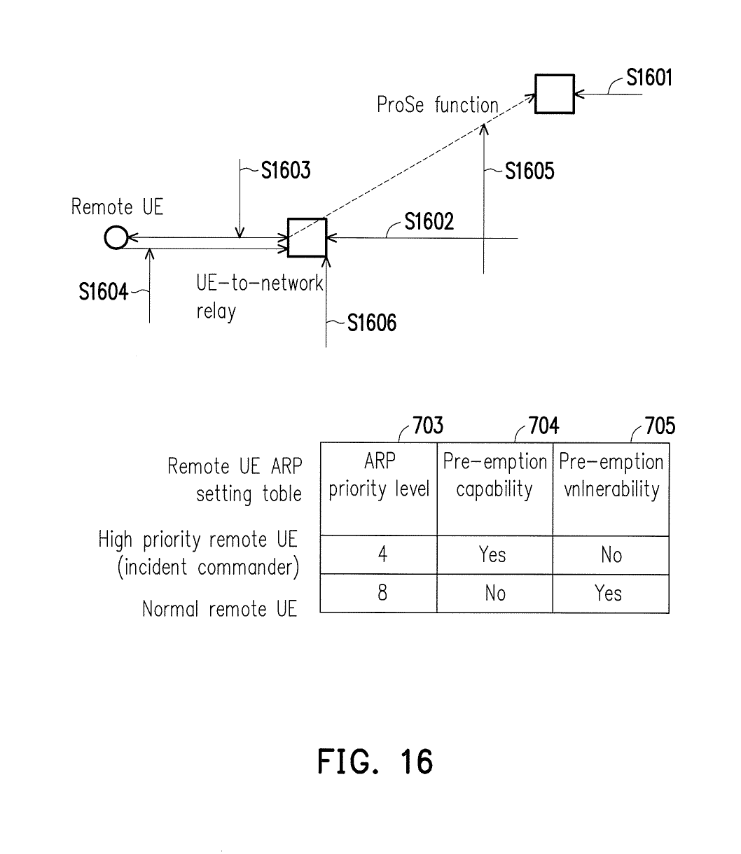

FIG. 16 illustrates an example of accepting a high priority UE during high network traffic in accordance with one of the exemplary embodiments of the disclosure. In this exemplary embodiment, a public safety ProSe-enabled UE would operate as a relay to accept only communication requests from higher prioritized remote users such as an incident commanders in order to avoid getting overloaded. If an overload has already overloaded, the bearers with lower ARP priorities would be released to create resources for users with higher ARP priorities such as incident commanders.

In step S1601, the ProSe Function would receive a ‘Remote UE ARP Setting Table’ from a HSS. In step S1602, a UE-to-Network Relay would receive PCC rules and thresholds which would indicate, for example, if UE-to-Network Relay operates at 80% of capacity, only Remote UEs with ARP <5 are allowed to use that relay. In step S1603, a direct discovery would be performed by a Remote UE to discover one or several relay nodes. If the Remote UE has discovered several relay nodes, one would be selected for a direct one to one communication. In step S1604, if the Remote UE would attempt establish the one to one communication with the UE-to-Network Relay, and a static or dynamic ID address would then be assigned for the remote UE. In step S1605, the UE-to-Network Relay would check for Remote UE's ARP setting by referring to a table such as the one below FIG. 16 for example. In the case if the UE-to-Network Relay has received that information already such as during the aforementioned direct discovery phase, accessing the ProSe function may not be required. In step S1606, the UE-to-Network Relay may accept the communication request of the Remote UE in accordance with PCC rules and thresholds. In the case when no resources are available, the UE-to-Network Relay may release the connection of the Remote UE with the lowest ARP priority level and the pre-emption vulnerability flag set to ‘yes’.

In view of the aforementioned descriptions, the present disclosure is suitable for being used in a wireless communication system and is able to dynamically adjust QoS related settings of an EPS bearer in order for a public safety ProSe-enabled UE to achieve the optimal relaying functionalities without being pre-emptied in unfortunate circumstances.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method of dynamic admission control applicable to a ProSe server, the method comprising:
receiving an allocation and retention priority (ARP) setting table which indicates a plurality of ARP settings per wireless device;
receiving, from the wireless device, a wireless signal which indicates that the wireless device has enabled a D2D relay functionality; and
modifying a first ARP setting of the wireless device to be a second ARP setting of the wireless device in response to that the wireless device has enabled the relay functionality according to the ARP setting table, wherein the second ARP setting has a higher priority level than the first ARP setting.

2. The method of claim 1 further comprising:
modifying the second ARP setting of the wireless device to a third ARP setting in response to that the wireless device is serving n users, wherein n>0 and the third ARP setting has a higher priority than the second ARP setting; and
updating the ARP setting table which records ARP settings.

3. The method of claim 2 further comprising:
modifying the third ARP setting of the wireless device to a fourth ARP setting in response to that the wireless device is serving m users, wherein m>n and the fourth ARP setting has a higher priority than the third ARP setting; and
updating the ARP setting table.

4. The method of claim 1 further comprising:
modifying the second ARP setting of the wireless device to a third ARP setting in response to that the wireless device is a high priority wireless device, and the third ARP setting has a higher priority than the second ARP setting.

5. The method of claim 1, wherein in response to that the wireless device has enabled the D2D relay functionality, modifying the ARP settings for the wireless device as being invulnerable for preemption.

6. The method of claim 2, wherein in response to that the wireless device is serving n users, wherein n>0, modifying the ARP settings for the wireless device as having preemption capability.

7. The method of claim 2 further comprising:
receiving the ARP settings table from a home subscriber server (HSS); and
saving the ARP settings table in a UE context.

8. The method of claim 1, wherein in response to the wireless device has enabled the D2D relay functionality, claim 1 further comprising:
informing a Policy Charging and Rules Function (PCRF) that the wireless device has enabled the D2D relay functionality.

9. The method of claim 2, wherein in response to that the wireless device has enabled the relay functionality, changing a pre-emption vulnerability flag (PVF) of the APR setting of the wireless device.

10. The method of claim 9, wherein in response to that the wireless device is serving n users, wherein n>0, changing a pre-emption capability flag (PCF) of the ARP setting of the wireless device.

11. A method of dynamic admission control applicable to a ProSe capable wireless device, the method comprising:
establishing a radio bear having a first allocation and retention priority (ARP) setting;
enabling a device to device (D2D) relay functionality;
modifying the first ARP setting of the UE to be a second ARP setting of the wireless device in response to that the wireless has enabled the relay functionality, wherein the second ARP setting has a higher priority level than the first ARP setting; and
transmitting a wireless signal which indicates that the wireless device has enabled the D2D relay functionality.

12. The method of claim 11 further comprising:
modifying the second ARP setting of a radio bearer to a third ARP setting in response to that the wireless device is serving n users, wherein n>0 and the third ARP setting has a higher priority than the second ARP setting.

13. The method of claim 12 further comprising:
modifying the third ARP setting of the radio bearer to a fourth ARP setting in response to that the wireless device is serving m users, wherein m>n and the fourth ARP setting has a higher priority than the third ARP setting.

14. The method of claim 11 further comprising:
modifying the second APR setting of the radio bearer to a third ARP setting in response to that the wireless device is a high priority wireless device, and the third ARP setting has a higher priority than the second ARP setting.

15. The method of claim 11, wherein in response to that the wireless device has enabled the D2D relay functionality, the wireless device is invulnerable for preemption.

16. The method of claim 12, wherein in response to that the wireless device is serving n users, wherein n>0, the wireless device possesses preemption capability.

17. The method of claim 11, wherein in response to the wireless device reaching maximum capability, releasing a remote user equipment (UE) having a lowest ARP setting.

18. The method of claim 17 further comprising:
in response to the wireless device reaching maximum capacity, only accepting the remote UE having a high ARP setting.

19. The method of claim 12, wherein in response to that the wireless device has enabled the relay functionality, changing a pre-emption vulnerability flag (PVF) of the ARP setting of the radio bearer.

20. The method of claim 19, wherein in response to that the wireless device is serving n users, wherein n>0, changing a pre-emption capability flag (PCF) of the ARP setting of the radio bearer.

21. A ProSe Server comprising:
a storage medium;
a transceiver; and
a processor coupled to the storage medium and the transceiver and is configured at least for:
receiving an ARP table which indicates a plurality of ARP settings per wireless device and storing the APR setting table in the storage medium;
receiving, via the transceiver, a wireless signal which indicates that the wireless device has enabled a D2D relay functionality from the wireless device; and
modifying a first ARP setting of the wireless device to be a second ARP setting of the wireless device according to the ARP setting table in response to that the wireless device has enabled the relay functionality, wherein the second ARP setting has a higher priority level than the first ARP setting.
